(19) United States
(12) Patent Application Publication
(10) Pub. No.: US 2010/0143227 A1
(43) Pub. Date: Jun. 10, 2010

(54) MIXED CATALYST FOR NOx REDUCTION AND METHODS OF MANUFACTURE THEREOF

(75) Inventors: Hrishikesh Keshavan, Clifton Park, NY (US); Benjamin Hale Winkler, Albany, NY (US); Dan Hancu, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/328,942

(22) Filed: Dec. 5, 2008

(51) Int. Cl. B01J 29/06; B01J 29/064; B01D 53/56; B01J 29/072

(52) U.S. Cl. 423/239.2; 502/60; 502/79; 502/78; 502/77; 502/74; 502/64; 502/62

(57) ABSTRACT

Disclosed herein is a catalyst comprising a binder; and a catalytic composition, the catalytic composition comprising a first catalyst composition that comprises a zeolite; and a second catalyst composition that comprises a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; wherein the catalyst is in the form of an extrudate or foam.

### FIELD OF THE INVENTION

The invention includes embodiments that relate to a catalyst composition. The invention also includes embodiments that relate to a method of making and/or using the catalyst composition.

### BACKGROUND OF THE INVENTION

Regulations continue to evolve regarding the reduction of oxide gases of nitrogen (NOx) for diesel engines in trucks and locomotives. NOx gases may be undesirable. A NOx reduction solution may include treating diesel engine exhaust with a catalyst that can reduce NOx to N₂ and O₂ using a reductant. This process may be referred to as selective catalytic reduction or SCR.

In selective catalytic reduction (SCR), a reductant, such as ammonia, is injected into the exhaust gas stream to react with NOx in contact with a catalyst. When ammonia is used, the molecule forms nitrogen and water. Three types of catalysts have been used in these systems. The types include base metal systems, and zeolite systems. Base metal catalysts operate in the intermediate temperature range (310 degrees Celsius to 400 degrees Celsius), but at high temperatures they may promote oxidation of SO₂ to SO₃. These base metal catalysts may include vanadium pentoxide and titanium dioxide. The zeolites may withstand temperatures up to 600 degrees Celsius and, when impregnated with a base metal, have a wide range of operating temperatures.

Hydrocarbons may also be used in the selective catalytic reduction of NOx emissions. NOx can be selectively reduced by a variety of organic compounds (e.g. alkanes, olefins, alcohols) over several catalysts under excess O₂ conditions. The injection of diesel or methanol has been explored in heavy-duty stationary diesel engines to supplement the hydrocarbon in the exhaust stream. However, the conversion efficiency may be reduced outside the narrow temperature range of 300 degrees Celsius to 500 degrees Celsius. In addition, there may be other undesirable properties.

A selective catalytic reduction catalyst may include catalytic metals disposed upon a porous substrate. However, these catalysts often do not function properly when NOx reduction is desired. In addition, catalyst preparation and deposition on a substrate may be involved and complex. As a result, the structure and/or efficacy of the catalyst may be compromised during manufacture. It is therefore desirable to have catalysts that can effect NOx reduction across a wide range of temperatures and operating conditions. It is also desirable if the method and apparatus can be implemented on existing engines and do not require large inventories of chemicals. It is further desirable to have a method of making such catalysts that does not require washcoating a substrate, whereby the processing steps do not compromise the catalyst activity.

### BRIEF SUMMARY OF THE INVENTION

In accordance with one embodiment of the invention, there is provided a catalyst comprising a binder; and a catalytic composition, the catalytic composition comprising a first catalyst composition that comprises a zeolite; and a second catalyst composition that comprises a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; wherein the catalyst is in the form of an extrudate or foam.

In accordance with another embodiment of the invention, there is provided a method of making a catalyst, comprising combining a first catalyst composition, a second catalyst composition, and a binder to form an intermediate catalytic composition; the first catalyst composition comprising a zeolite; the second catalyst composition comprising a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; and forming the intermediate catalytic composition into a foam or extrudate.

In accordance with another embodiment of the invention, there is provided a method of reducing NOx comprising exposing an exhaust gas stream comprising NOx to a catalyst; the catalyst comprising a binder and a catalytic composition, the catalytic composition comprising a first catalyst composition that comprises a zeolite; and a second catalyst composition that comprises a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; wherein the catalyst in the form of an extrudate or foam.

### DETAILED DESCRIPTION OF THE INVENTION

The invention includes embodiments that relate to a foam or extrudate catalyst. The catalyst is effective for reducing NOx present in emissions generated during combustion in furnaces, ovens, and engines.

As used herein, without further qualifiers a “catalyst” is a substance that can cause a change in the rate of a chemical reaction without itself being consumed in the reaction. A “slurry” is a mixture of a liquid and finely divided particles. A “powder” is a substance including finely dispersed solid particles. As used herein, the term “calcination” is a process in which a material is heated to a temperature below its melting point to effect a thermal decomposition or a phase transition other than melting. A “zeolite” is a crystalline metal oxide material that comprises a micro-porous structure.

In one embodiment, the catalyst comprises a binder, and a catalytic composition including a first catalyst composition and a second catalyst composition. The first catalyst composition and the second catalyst composition are mixed together to form a mixture that reduces NOx present in an emissions stream. The first catalyst composition comprises a zeolite while the second catalyst composition comprises a catalytic metal disposed upon a porous inorganic material. The inorganic material may be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or the like, or a combination comprising at least one of the foregoing inorganic materials. When the catalyst is employed to reduce NOx generated in emissions from furnaces, ovens and engines, a variety of hydrocarbons can be effectively used as a reductant. In one embodiment, diesel can be used as a reductant. The catalyst can reduce NOx while using higher hydrocarbons having from about 5 to about 9 carbon atoms as a reductant. The catalyst advantageously functions well across all temperature ranges, especially at temperatures of about 325 degrees Celsius to about 400 degrees Celsius.

The first catalyst composition comprises a zeolite. The zeolites may be naturally occurring or synthetic, and may be in the form of a powder. Examples of suitable zeolites are zeolite Y, zeolite beta, ferrierite, mordenite, zeolite ZSM-5, or a combination comprising at least one of the foregoing zeolites. Zeolite ZSM-5 is commercially available from Zeolyst International (Valley Forge, Pa.). In one embodiment, the zeolite is a ferrierite having a silicon to aluminum ratio of about 20.

Examples of commercially available zeolites that may be used in the first catalyst composition are marketed under the following trademarks: CBV100, CBV300, CBV400, CBV500, CBV600, CBV712, CBV720, CBV760, CBV780, CBV901, CP814E, CP814C, CP811C-300, CP914, CP914C, CBV2314, CBV3024E, CBV5524G, CBV8014, CBV28014, CBV10A, CBV21A, CBV90A. The foregoing zeolites are available from Zeolyst International, and may be used individually or in a combination comprising two or more of the zeolites.

In one embodiment, the zeolite particles may have an average particle size of less than about 50 micrometers. In one embodiment, the zeolite particles have an average particle size of about 50 micrometers to about 400 micrometers. In one embodiment, the zeolite particles have an average particle size of about 400 micrometers to about 800 micrometers. In another embodiment, the zeolite particles have an average particle size of about 800 micrometers to about 1600 micrometers.

The zeolite particles may have a surface area of about 200 m²/gm to about 300 m²/gm. In one embodiment, the zeolite particles may have a surface area of about 300 m²/gm to about 400 m²/gm. In another embodiment, the zeolite particles have a surface area of about 400 m²/gm to about 500 m²/gm. In yet another embodiment, the zeolite particles have a surface area of about 500 m²/gm to about 600 m²/gm.

Prior to combining the first and second catalyst compositions, the zeolite may be calcined to produce the H form of the zeolite, which has been found to be advantageous. The H form of the zeolite is the protonic form of the zeolite. Commercially available zeolites are typically obtained in the NH₄ form. During calcination, NH₃ is released to create the H form of the zeolite. In one embodiment, the zeolite does not comprise any metal ions. It is important that the zeolite remains in the H form during preparation of the catalyst. For example, if Ag attaches to the zeolite (e.g. Ag-CP914C), the catalytic mixture may not show the desired catalytic activity.

The parameters used for calcination will depend on the type of zeolite used. In one embodiment, the zeolite is calcined at a temperature in a range from about 100 degrees Celsius to about 300 degrees Celsius. In one embodiment, the zeolite is calcined at a temperature in a range from about 300 degrees Celsius to about 600 degrees Celsius. In another embodiment, the zeolite is calcined in air at a temperature in a range from about 600 degrees Celsius to about 900 degrees Celsius. In yet another embodiment, the zeolite is calcined in N₂ at 100 degrees Celsius for 1 hr, at 550 degrees Celsius for 1 hr, and then in air at 550 degrees Celsius for 5 hrs. Alternatively, the zeolite can be calcined in air at 550 degrees Celsius for 4 hrs with a very slow ramp rate such as 1 degree Celsius per minute in a dry air feed. The zeolite can also be calcined under vacuum at similar conditions so as to avoid alteration of the cage structure.

Desirably, the first catalyst composition is present in an amount of from about 20 weight percent to about 30 weight percent, from about 30 weight percent to about 40 weight percent, from about 40 weight percent to about 50 weight percent, from about 50 weight percent to about 60 weight percent, from about 60 weight percent to about 70 weight percent, or from about 70 weight percent to about 80 weight percent, based upon the total weight of the catalytic composition.

As noted above, the second catalyst composition comprises a metal disposed upon a porous inorganic material. The porous inorganic materials are metal oxides, inorganic oxides, inorganic carbides, inorganic nitrides, inorganic hydroxides, inorganic oxides having a hydroxide coating, inorganic carbonitrides, inorganic oxynitrides, inorganic borides, inorganic borocarbides, or a combination comprising at least one of the foregoing inorganic materials.

Examples of suitable inorganic oxides include silica (SiO₂), alumina (Al₂O₃), titania (TiO₂), zirconia (ZrO₂), ceria (CeO₂), manganese oxide (MnO₂), zinc oxide (ZnO), iron oxides (e.g., FeO, β-Fe₂O₃, γ-Fe₂O₃, ε-Fe₂O₃, Fe₃O₄, or the like), calcium oxide (CaO), manganese dioxide (MnO₂ and Mn₃O₄), or combinations comprising at least one of the foregoing inorganic oxides. Examples of inorganic carbides include silicon carbide (SiC), titanium carbide (TiC), tantalum carbide (TaC), tungsten carbide (WC), hafnium carbide (HfC), or the like, or a combination comprising at least one of the foregoing carbides. Examples of suitable nitrides include silicon nitrides (Si₃N₄), titanium nitride (TiN), or the like, or a combination comprising at least one of the foregoing. Examples of suitable borides are lanthanum boride (LaB₆), chromium borides (CrB and CrB₂), molybdenum borides (MoB₂, Mo₂B₅ and MoB), tungsten boride (W₂B₅), or the like, or combinations comprising at least one of the foregoing borides. In one embodiment, the inorganic substrate is alumina.

The porous inorganic material may have a surface area of from about 100 m²/g to about 200 m²/gm, to about 200 m²/g to about 300 m²/gm, from about 300 m²/g to about 400 m²/gm, from about 400 m²/g to about 500 m²/gm, from about 500 m²/g to about 600 m²/gm, from about 600 m²/g to about 700 m²/gm, from about 700 m²/g to about 800 m²/gm, from about 800 m²/g to about 1000 m²/gm, from about 1000 m²/g to about 1200 m²/gm, from about 1200 m²/g to about 1300 m²/gm, from about 1300 m²/g to about 1400 m²/gm, from about 1400 m²/g to about 1500 m²/gm, from about 1500 m²/g to about 1600 m²/gm, from about 1600 m²/g to about 1700 m²/gm, from about 1700 m²/g to about 1800 m²/gm, or from about 1800 m²/g to about 2000 m²/gm. In an exemplary embodiment, the porous inorganic material has a surface area in a range of from about 200 m²/g to about 500 m²/g.

The porous inorganic material may be in the form of particles. Both the porous inorganic material and the second catalyst composition may in the form of a powder.

The porous inorganic material has an average particle size of about 0.2 micrometers to about 5 micrometers. In one embodiment, the porous inorganic material has an average particle size of about 5 micrometers to about 25 micrometers. In another embodiment, the porous inorganic material has an average particle size of about 25 micrometers to about 50 micrometers. In another embodiment, the porous inorganic material has an average particle size of about 50 micrometers to about 75 micrometers. In another embodiment, the porous inorganic material has an average particle size of about 75 micrometers to about 100 micrometers. In an exemplary embodiment, the porous inorganic material has an average particle size of about 40 micrometers.

The catalytic metal comprises alkali metals, alkaline earth metals, transition metals and main group metals. Examples of suitable catalytic metals are silver, platinum, gold, palladium, iron, nickel, cobalt, gallium, indium, ruthenium, rhodium, osmium, iridium, or the like, or a combination comprising at least two of the foregoing metals. In one embodiment, the second catalytic metal is silver. Other suitable catalytic materials may include one or more other noble metals. Other suitable catalytic materials may include one or more transitional metals. Other suitable catalytic materials may include one or more metals in the lanthanide series such as cerium and samarium.

The average catalytic metal particle size is about 0.1 nanometer to about 500 nanometers. The catalytic metal is present in the second catalyst composition in an amount of about 0.025 mole percent (mol %) to about 5 mol %. In one embodiment, the catalytic metal is present in the second catalyst composition in an amount of about 5 mol % to about 20 mol %. In another embodiment, the catalytic metal is present in the second catalyst composition in an amount of about 20 mol % to about 30 mol %. In one embodiment, the catalytic metal is present in the second catalyst composition in an amount of about 30 mol % to about 40 mol %. In yet another embodiment, the amount of catalytic metal in the second catalyst composition is about 40 mol % to about 50 mol %.

The first catalyst composition and the second catalyst composition may each be in the form of a powder. Prior to combining the first catalyst composition and the second catalyst composition, the catalyst compositions may be milled or pulverized to reduce their particle sizes to the desired ranges disclosed herein. In one embodiment, the second catalyst composition may be formed by first milling the porous inorganic material, and then adding the catalytic metal to the porous inorganic material. Suitable methods for milling the first and second catalyst compositions include ball milling, ultrasonic milling, planetary milling, jet milling, or a combination thereof. In one embodiment, the first and second catalyst compositions are ball milled.

In one embodiment, a second catalyst composition powder is formed in the following manner. The catalytic metal and the porous inorganic material are combined with a solvent to form a second catalyst slurry. Suitable solvents for forming the slurry include water, alcohols such as short chain alcohols, polar protic solvents and polar aprotic solvents. The second catalyst slurry is then milled using any of the techniques described hereinabove. The second catalyst slurry is then dried by spray drying, freeze-drying, or super-critical drying, followed by calcination to form the second catalyst composition powder.

The parameters used for calcination of the second catalyst composition will depend on the type of catalytic metal and the porous inorganic material used to form the composition. In one embodiment, the second catalyst composition is calcined in air at a temperature in a range from about 100 degrees Celsius to about 400 degrees Celsius. In another embodiment, the second catalyst composition is calcined at a temperature in a range from about 400 degrees Celsius to about 800 degrees Celsius. In yet another embodiment, the second catalyst composition is calcined in air at a temperature in a range from about 800 degrees Celsius to about 1100 degrees Celsius.

The second catalyst composition is generally present in the catalytic composition in an amount of about 20 weight percent to about 40 weight percent, based upon the total weight of the catalyst composition. In one embodiment, the second catalyst composition is present in an amount of about 40 weight percent to about 60 weight percent, based upon the total weight of the catalytic composition. In another embodiment, the second catalyst composition is present in an amount of about 60 weight percent to about 80 weight percent, based upon the total weight of the catalytic composition. In an exemplary embodiment, the second catalyst composition is present in an amount of about 45 weight percent to about 55 weight percent, based upon the total weight of the catalytic composition.

Examples of suitable binders for use in the catalyst include permanent binders and temporary binders. The binders may be organic or inorganic binders. A permanent binder is added to the catalyst and is not removed. An example of a permanent binder is boehmite. Temporary binders are usually organic and are added to the catalyst to aid in extrusion and forming foams. Temporary binders are typically removed upon calcination of the catalyst. Examples of temporary binders include saw dust, methylcellulose type binders and sugar.

The binder is combined with the first catalyst composition and the second catalyst composition to form an intermediate catalyst composition. In one embodiment, the first catalyst composition and the second catalyst composition are first combined to form a catalytic composition. The binder is then added to the catalytic composition to form the intermediate catalytic composition.

In one embodiment, the intermediate catalytic composition is formed into an extrudate using any method known to those skilled in the art. In one embodiment an extrusion mull is prepared from the catalytic composition. The extrusion mull is prepared by mixing the components of the intermediate catalytic composition together until a homogenous mull is formed. A high-speed planetary mixer may be used to form the extrusion mull. The mull is then passed through an extruder such as a BB Gun extruder, available from The Bonnot Company, Uniontown, Ohio.

In one embodiment the extrudate has a thickness in a range of from about 1.0 mm to about 4.0 mm. In one embodiment the extrudate has a thickness in a range of from about 4.0 mm to about 7.0 mm. In another embodiment the extrudate has a thickness in a range of from about 7.0 mm to about 9.0 mm. In yet another embodiment, the extrudate has a thickness in a range of from about 9.0 mm to about 12 mm.

Following the extruding process, the extrudate is dried. The extrudate may be dried at a temperature in a range of from about 25 degrees Celsius to about 40 degrees, from about 40 degrees Celsius to about 80 degrees Celsius or from about 80 degrees Celsius to about 110 degrees Celsius. In one embodiment, the extrudate is dried in a box oven at a temperature of 80 degrees Celsius for approximately 6 hours.

The extrudate is then calcined at a temperature in a range of from about 400 degrees Celsius to about 500 degrees Celsius. In another embodiment, the extrudate is calcined at a temperature in a range from about 500 degrees Celsius to about 600 degrees Celsius. In yet another embodiment, the extrudate is calcined at a temperature in a range from about 600 degrees Celsius to about 800 degrees Celsius.

In an alternative embodiment, the intermediate catalytic composition comprises a foaming agent, and the composition is formed into a foam using any method known in the art. For example, a foam may be produced by gel casting the intermediate catalytic composition.

Any suitable foaming agent may be used in the intermediate catalytic composition. For example, the foaming agent may be an organic solvent that foams under heat or via a chemical reaction. Suitable organic solvents include, but are not limited to Hypol®, a hydrophilic polyurethane prepolymer available from Dow Chemical Company. Alternatively, the foaming agent may be a template, such as a polyurethane foam or a cellulose foam.

If a foaming agent template is utilized, the intermediate catalytic composition is formed into a slurry. The slurry comprises the first catalyst composition, the second catalyst composition, binder and a solvent. Suitable solvents for forming the catalytic composition slurry include water, alcohols such as short chain alcohols, polar protic solvents and polar aprotic solvents. The foaming agent template is then immersed in the intermediate catalytic slurry.

After immersing the foaming agent template into the slurry, the template is calcined at a temperature between about 200 degrees Celsius and about 500 degrees Celsius, from about 500 degrees Celsius to about 800 degrees Celsius or from about 800 degrees Celsius to about 1100 degrees Celsius. The coated foaming agent template typically is first calcined to burn off the template. This temperature is based on TGA-DTA analysis on the foaming agent template. Typically the sample is isothermally soaked at a temperature just below where the foaming agent starts to decompose and held for an extended period of time until all the organic foaming agent is removed. The calcination then proceeds further at a higher temperature.

In one embodiment, the catalyst is disposed in the exhaust stream of an internal combustion engine. The internal combustion engine can be present in an automobile or in a locomotive. The catalyst reduces NOx to nitrogen at rates that are superior to conventional catalysts.

The following examples, which are meant to be exemplary, not limiting, illustrate compositions and methods of making some of the various embodiments of the catalysts described herein.

### EXAMPLES

### Example 1

### Preparation of Second Catalyst Composition

γ-Al₂O₃ can be obtained commercially from various sources including UOP LLC, Des Plaines, Ill. AgNO₃, ethanol and high purity ZrO₂ media are added to the γ-Al₂O₃ to form a second catalyst slurry as indicated in Table 1. The second catalyst slurry is ball milled for 24 hours and dried at 80 degrees Celsius for 8 hours. The fine powder is calcined in air slowly to 600 degrees Celsius to form Ag—Al₂O₃.

TABLE 1
Slurry preparation for Ag—Al₂O₃

| Alumina (g) | AgNO₃ (g) | Ethanol (g) | ZrO₂ (g) | Mill time (h) |
|---|---|---|---|---|
| 50 | 2.435 | 50.00 | 100 | 24 |

### Example 2

### Preparation of Second Catalyst Composition

A second catalyst slurry is prepared by combining 30 g of γ-Al₂O₃, 70 g of water, and 250 g of high purity ZrO₂ media. HNO₃ is added to the slurry to adjust the pH of the slurry to between 3.5 and 4.5. The slurry is ball milled for 24 hours, and 2.3 g of AgNO₃ is added to the slurry. The second catalyst slurry is ball milled for an additional 30 minutes, and then freeze dried in a Mill Rock freeze dryer under a pressure of 300 mTorr. The freeze drying cycle is shown in Table 2 below.

TABLE 2
Freeze Drying Cycle

| Temp (° C.) | Time (min) |
|---|---|
| −55 | 240 |
| −50 | 240 |
| −45 | 240 |
| −40 | 240 |
| −35 | 240 |
| −30 | 240 |
| −25 | 240 |
| −20 | 240 |
| −15 | 240 |
| −10 | 240 |
| −5 | 240 |
| 0 | 240 |
| 5 | 240 |
| 10 | 240 |
| 15 | 240 |
| 20 | 240 |
| 25 | 240 |
| 30 | 240 |
| 35 | 240 |
| 40 | 240 |

### Example 3

### Preparation of First Catalyst Composition

Ferrierite zeolite CP914C obtained from Zeolyst International, Valley Forge, Pa. was calcined in order to convert the ferrierite to its H form. The ferrierite powder is calcined in N₂ at 110 degrees Celsius for 1 hr, at 550 degrees Celsius for 1 hr, and then in air at 550 degrees Celsius for 1 hr.

### Example 4

### Preparation of Catalyst Extrudate

The Ag—Al₂O₃ powder prepared in Example 1 and the ferrierite zeolite powder prepared in Example 3 are combined in a ratio of 4:1. The powders are mixed together with a high speed planetary mixer. The powders are mixed in multiple cycles at 2000 rpm for 30 seconds, until a homogenous mull is formed.

The mull is extruded in a BB Gun extruder with an auger speed of 5 rpm at 1000 psi to form extrudates having a thickness of 1/16 inch. The extrudates are dried in an oven at 80 degrees Celsius for 4 hrs, and then calcined in dry air with a molecular sieve oil filter to trap any organics in the air feed. The extrudates are calcined at 600 degrees Celsius for 4 hrs.

### Example 5

### Preparation of Catalyst Foam

The Ag—Al₂O₃ powder prepared in Example 1 and the ferrierite zeolite powder prepared in Example 3 are combined in a ratio of 4:1. Water is added to the powder mixture to form a slurry. A polyurethane foam is immersed in the slurry. The excess slurry is removed from the foam by gently squeezing the foam. The foam is dried at 100 degrees Celsius for 3 hours, and the foam is then calcined as indicated in Table 3. The dwell time is the period of time the foam is kept at a specific temperature, i.e. the isothermal hold time.

TABLE 3
Calcination Cycle for Catalyst Foam

| Atmosphere | Ramp Rate | Temp (° C.) | Dwell time (hr) |
|---|---|---|---|
| Nitrogen | 1 | 125 | 2 |
| Nitrogen | 1 | 250 | 10 |
| Nitrogen | 1 | 550 | 4 |
| Air | — | 550 | 5 |
| Air | 1 | 25 | — |

All ranges disclosed herein are inclusive of the endpoints, and the endpoints are combinable with each other. The terms “first,” “second,” and the like as used herein do not denote any order, quantity, or importance, but rather are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A catalyst comprising:
a binder; and
a catalytic composition, the catalytic composition comprising:
a first catalyst composition that comprises a zeolite; and
a second catalyst composition that comprises a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials;
wherein the second catalyst composition is present in an amount from 45 weight percent up to 80 weight percent based upon the weight of the catalytic composition; and
wherein the catalyst comprising the binder and catalytic composition is in the form of an extrudate or foam.

2. The catalyst of claim 1, wherein the zeolite is zeolite Y, zeolite beta, ferrierite, mordenite, ZSM-5, or a combination comprising at least one of the foregoing zeolites.

3. The catalyst of claim 1, wherein the zeolite comprises ferrierite.

4. The catalyst of claim 3, wherein the ferrierite has silicon to aluminum molar ratio of 20.

5. The catalytst of claim 3, wherein the ferrierite has a surface area of about 200 to about 500 m2/gm.

6. The catalytst of claim 1, wherein the catalytic metal is silver, gold, palladium, cobalt, nickel, iron, or a combination comprising at least one of the foregoing metals.

7. The catalyst of claim 1, wherein the porous inorganic material is silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, or combinations comprising at least one of the foregoing borides.

8. The catalyst of claim 1, comprising the first catalyst composition in an amount of about 20 weight percent to about 80 weight percent, based upon the weight of the catalytic composition.

9. The catalyst of claim 1, wherein the binder comprises boehmite, saw dust, methylcellulose or sugar.

10. The catalyst of claim 1, wherein the catalyst is in the form of an extrudate, and wherein the extrudate has a thickness in a range from about 1.0 mm to about 12 mm.

11. A method of making a catalyst, comprising:
combining a first catalyst composition, a second catalyst composition, and a binder to form an intermediate catalytic composition; the first catalyst composition comprising a zeolite; the second catalyst composition comprising a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; and
forming the intermediate catalytic composition into a foam or extrudate.

12. The method of claim 11, wherein the intermediate catalytic composition is formed into a foam, and the method further comprises:
adding a solvent to the intermediate catalytic composition to form a slurry;
immersing a foaming agent template in the slurry;
and calcining the foaming agent template.

13. The method of claim 12, wherein the foaming agent template is calcined at a temperature in a range between about 200 degrees Celsius and about 1100 degrees Celsius.

14. The method of claim 11, wherein the intermediate catalytic composition is formed into a foam, and the foam is formed by gel casting.

15. The method of claim 11, wherein the intermediate catalytic composition is formed into an extrudate, and the method further comprises:
drying the extrudate; and
calcining the extrudate.

16. The method of claim 15, wherein the extrudate is calcined at a temperature in a range from about 400 degrees Celsius to about 800 degrees Celsius.

17. The method of claim 11, further comprising:
milling the first catalyst composition prior to forming the intermediate catalytic composition.

18. The method of claim 11, further comprising:
milling the second catalyst composition prior to forming the intermediate catalytic composition.

19. The method of claim 11, wherein the zeolite is zeolite Y, zeolite beta, ferrierite, mordenite, ZSM-5, or a combination comprising at least one of the foregoing zeolites.

20. The method of claim 11, wherein the catalytic metal is silver, gold, palladium, cobalt, nickel, iron, or a combination comprising at least one of the foregoing metals.

21. The method of claim 11, wherein the porous inorganic material is silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, or combinations comprising at least one of the foregoing borides. .

22. A method of reducing NOx comprising:
exposing an exhaust gas stream comprising NOx to a catalyst; the catalyst comprising a binder and a catalytic composition, the catalytic composition comprising:
a first catalyst composition that comprises a zeolite; and
a second catalyst composition that comprises a catalytic metal disposed upon a porous inorganic material, wherein the porous inorganic material is a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or a combination comprising at least one of the foregoing inorganic materials; the first catalyst composition and the second catalyst composition being mixed together to form a mixture;
wherein the catalyst in the form of an extrudate or foam.

23. The method of claim 22, wherein the zeolite is zeolite Y, zeolite beta, ferrierite, mordenite, ZSM-5, or a combination comprising at least one of the foregoing zeolites.

24. The method of claim 22, wherein the catalytic metal is silver, gold, palladium, cobalt, nickel, iron, or a combination comprising at least one of the foregoing metals.

25. The method of claim 22, wherein the porous inorganic material is silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, or combinations comprising at least one of the foregoing borides.
